(19) United States
(12) Patent Application Publication
(10) Pub. No.: US 2024/0249150 A1
(43) Pub. Date: Jul. 25, 2024

(54) SYSTEM FOR ALLOCATING DEEP NEURAL NETWORK TO PROCESSING UNIT BASED ON REINFORCEMENT LEARNING AND OPERATION METHOD OF THE SYSTEM

(71) Applicant: Samsung Electronics Co., Ltd., Suwon-si (KR)

(72) Inventors: Sungwoo CHUNG, Seoul (KR); Younggeun KIM, Seoul (KR); Seunghun CHOI, Seoul (KR)

(73) Assignees: Samsung Electronics Co., Ltd., Suwon-si (KR); Korea University Research and Business Foundation, Seoul (KR)

(21) Appl. No.: 18/414,875

(22) Filed: Jan. 17, 2024

(30) Foreign Application Priority Data
Jan. 19, 2023 (KR) 10-2023-0008105

(51) Int. Cl. G06N 3/092

(52) U.S. Cl. CPC G06N 3/092

(57) ABSTRACT

Provided is a system configured to respectively allocate a plurality of deep neural networks to a plurality of processing units according to a particular action having maximum quality in a particular state. In addition, provided is a system configured to respectively allocate a plurality of deep neural networks to a plurality of processing units according to an action having maximum quality in a current state, and to update quality of an action selected in the current state by using a calculated reward based on a process of the plurality of deep neural networks by the allocated plurality of processing units.

### CROSS-REFERENCE TO RELATED APPLICATION

This application is based on and claims priority under 35 U.S.C. § 119 to Korean Patent Application No. 10-2023-0008105, filed on Jan. 19, 2023, in the Korean Intellectual Property office, the disclosure of which is incorporated by reference herein in its entirety.

### BACKGROUND

The inventive concepts relate to a system for allocating a deep neural network (DNN) to a processing unit based on reinforcement learning and an operation method of the system. More particularly, the inventive concepts relate to a system for efficiently and respectively allocating a plurality of DNNs to a plurality of processing units based on reinforcement learning.

Advances in DNN algorithms provide various intelligent services (for example, virtual assistant, face/image recognition, language translation, live video analysis, and augmented reality/virtual reality (AR/VR)), and the like. Multiple DNNs are used for intelligent services having complex functions. For example, for an AR application, multiple DNNs including object detection DNN, image classification DNN, and pause estimation DNN are used. Depending on the desired intelligent service, various DNNs are utilized for workloads of the multiple DNNs.

DNN processing is performed at a centralized data center due to computational and memory-intensive nature. Alternatively, the DNN processing is performed on mobile devices to improve response time by reducing network latency, reduce the communication burden with centralized servers, and prevent personal information leakage during communication.

The DNN processing may be performed by a processing unit, such as a central processing unit (CPU), a graphics processing unit (GPU), a neural processing unit (NPU), and/or the like. The demand for efficient processing of intelligent services having complex functions causes a problem of allocating a plurality of DNNs to a plurality of processing units.

### SUMMARY

The inventive concepts provide a method of efficiently and respectively allocating a plurality of deep neural networks (DNNs) to a plurality of processing units based on reinforcement learning.

The inventive concepts provide a system for allocating DNNs to the processing units based on reinforcement learning.

The system includes a memory configured to store one or more instructions; and the plurality of processors, wherein at least one processor of the plurality of processors, by performing the one or more instructions, is configured to: select a current state from a plurality of preset states, the current state corresponding to a state of the system and to a plurality of preset actions having at least one preset quality, select an action, of the plurality of preset actions, having a maximum quality in the current state and respectively allocate a plurality of deep neural networks (DNNs) to the plurality of processors based on the selected action, determine a reward based on whether a process of the plurality of DNNS by the allocated plurality of processors satisfies preset constraints, and update the at least one preset quality of the action selected in the current state based on the reward.

The inventive concepts provide a system for allocating DNNs to processing units based on reinforcement learning.

The system includes a memory configured to store one or more instructions; and a plurality of processing units, wherein at least one processor, of the plurality of processing units, by executing the one or more instructions, is configured to select a particular state from a plurality of preset states, the particular state corresponding to a state of the system and to a plurality of preset actions having at least one preset quality, select a particular action, of the plurality of preset actions, having a maximum quality in the particular state, and respectively allocate a plurality of deep neural networks to the plurality of processors based on the selection of the particular action.

The inventive concepts provide an operation method for allocating DNNs to processing units based on reinforcement learning.

The operation method of the system includes selecting a particular state from a plurality of preset states, the particular state corresponding to a state of a system and to a plurality of preset actions having at least one preset quality; selecting a particular action, from the plurality of preset actions, having a maximum quality in the particular state; and respectively allocating a plurality of DNNs to a plurality of processors based on the selection of the particular action.

### BRIEF DESCRIPTION OF THE DRAWINGS

Embodiments will be more clearly understood from the following detailed description taken in conjunction with the accompanying drawings in which:

FIG. 1 is a diagram of a plurality of deep neural networks (DNNs), according to at least one embodiment;

FIG. 2 is a diagram of Q-learning according to at least one embodiment;

FIG. 3 is a diagram of a Q-table according to at least one embodiment;

FIG. 4 is a diagram of a system according to at least one embodiment;

FIG. 5 is a diagram describing a learning method of respectively allocating a plurality of DNNs to a plurality of processing units, according to at least one embodiment;

FIG. 6 is a diagram describing a method of respectively allocating a plurality of DNNs to a plurality of processing units, according to at least one embodiment;

FIG. 7 is a table describing features for states according to at least one embodiment;

FIGS. 8 and 9 are tables describing states according to embodiments;

FIGS. 10 and 11 are tables describing actions according to embodiments;

FIG. 12 is a diagram describing compensation according to at least one embodiment;

FIGS. 13 and 14 are flowcharts of learning methods of a system for allocating DNNs to processing units based on reinforcement learning, according to embodiments;

FIGS. 15 and 16 are flowcharts of operating methods of a system for allocating DNNs to processing units based on reinforcement learning, according to embodiments; and

FIG. 17 illustrates graphs of performance of a process, according to at least one embodiment.

### DETAILED DESCRIPTION OF THE EMBODIMENTS

Hereinafter, various embodiments of the inventive concepts are described in conjunction with the accompanying drawings.

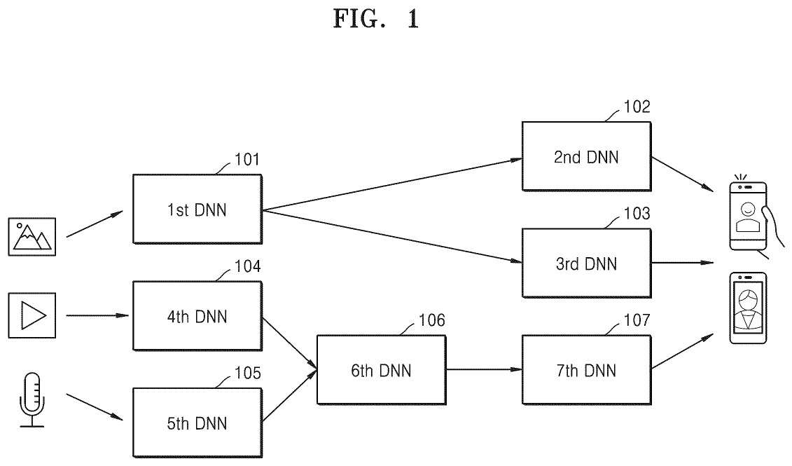

FIG. 1 is a diagram of a plurality of deep neural networks (DNNs), according to at least one embodiment.

A DNN may include a neural network based on deep learning in the artificial intelligence (AI) field. The DNN may include a convolution neural network (CNN), a recurrent neural network (RNN), a generative adversarial network (GAN), and/or the like. For example, the DNN may include at least one of LeNet, AlexNet, VGGNet, U-Net, residual neural network (ResNet), GoogleNet, ENet, and/or the like. In at least one embodiment, the type of DNN is not limited to the listed examples, and various types of DNNs may be used. Each of the plurality of DNN may be included in a processing unit, and/or a processing unit may comprise a sub-set of the plurality of DNN. For example, the plurality of DNN may be included in one or more processing units.

In at least one embodiment, a plurality of DNNs may include first through seventh DNNs 101 to 107. For example, the number of DNNs included in the plurality of DNNs is not limited thereto, and may be two or more.

The plurality of DNNs 101 to 107 may include different types of DNNs. Alternatively, at least two of the plurality of DNNs 101 to 107 may include the same type of DNN. For example, the second DNN 102 may include a U-Net-based CNN, the third DNN 103 may include a ResNet-based CNN, and the sixth DNN 106 may include an RNN.

The plurality of DNNs 101 through 107 may perform different functions. Alternatively, at least two of the plurality of DNNs 101 through 107 may perform the same function. For example, the first DNN 101 may perform object detection, the second DNN 102 may perform image classification, the third DNN 103 may perform face recognition, the fourth DNN 104 may convert voice into text, the fifth DNN 105 may convert an image into text, the sixth DNN 106 may perform language translation, the seventh DNN 107 may convert text into speech, and/or the like. However, in the example embodiments, the function of the DNN is not limited to the listed examples, and various functions of DNNs may be used, omitted, and/or added.

The plurality of DNNs may include a multiple DNNs. Herein, the multiple DNNs comprises a combination of DNNs linked in series and configured to obtain output data from input data. For example, when input data is processed by the first DNN 101 and the second DNN 102 to obtain first output data and input data is processed by the first DNN 101 and the third DNN 103 to obtain second output data, the first through third DNNs 101 through 103 may constitute multiple DNNs. For example, when the first input data is processed by the fourth DNN 104, the sixth DNN 106, and the seventh DNN 107 to obtain output data and the second input data is processed by the fifth DNN 105, the sixth DNN 106, and the seventh DNN 107 to obtain output data, the fourth through seventh DNNs 104 through 107 may constitute multiple DNNs.

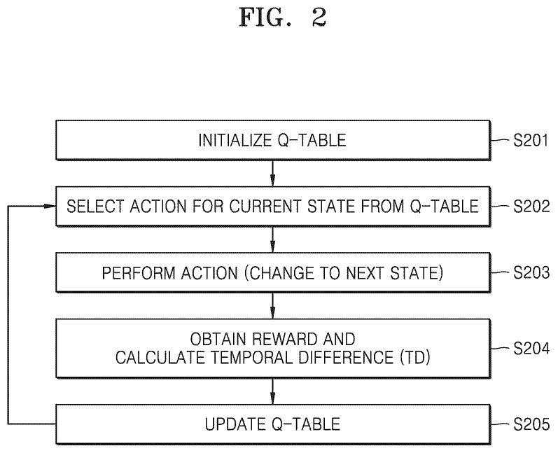

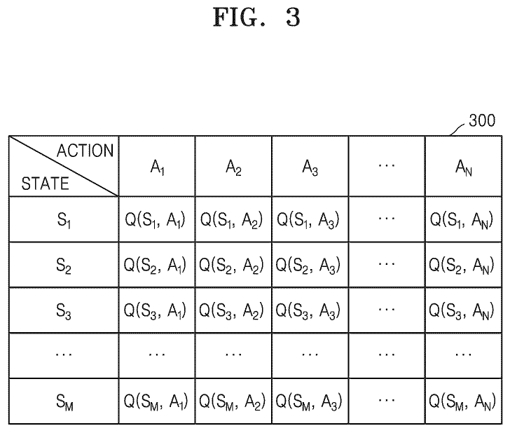

FIG. 2 is a diagram of Q-learning according to at least one embodiment. FIG. 3 is a diagram of a Q-table according to at least one embodiment.

The reinforcement learning is one type of machine learning. In the reinforcement learning, an agent seeks a policy for maximizing a reward. Q-learning, as a type of reinforcement learning, is performed in model-free environments. In other words, the agent does not want to learn about the underlying mathematical models, but attempts to construct an optimal policy by interacting with the environment. The agent repeatedly tries various approaches to solve problems, learn about the environment, and continuously update policies.

Referring to FIGS. 2 and 3, in operation S201, the agent may initialize a Q-table 300. The Q-table 300 represents a policy on how to act in an environment. A Q-value indicates the quality of an action. The Q-table 300 includes states and Q-values for actions. For example, Q(S₁, A₁) of the Q-table 300 respectively represents the quality of a first action A₁ taken in a first state S₁. The Q-table 300 may be initialized with any values.

In operation S202, the agent may select an action for a current state from the Q-table 300. The agent may select an action for the largest Q-value in the current state. When the current state is Sᵢ, the agent may select Aⱼ for the largest Q-value from Q(Sᵢ, A₁), Q(Sᵢ, A₂), . . . , Q(Sᵢ, A_{N}). For example, when the current state is S₃ and Q(S₃, A₂) is the largest among Q(S₃, A₁), Q(S₃, A₂), . . . , Q(S₃, A_{N}), the agent may select A₂. Alternatively, the agent may select an action based on an algorithm for exploration.

In operation S203, the agent may perform an action. In other words, the agent may perform the action selected in operation S202. The current state may be switched to a next state by the action performed by the agent.

In operation S204, the agent may obtain a reward, and calculate a temporary difference (TD). The TD may indicate how much the Q-value for the action taken in the previous state (that is, the current state before having been switched to the next state) is required to be changed. The TD may be calculated by using Equation 1.

$$TD ( S , A ) = R + γ {max}_{A ′} Q ( {S}^{′} , {A}^{′} ) - Q ( S , A ) \qquad [ Equation 1 ]$$

In Equation 1, R indicates a reward obtained by the action taken in the previous state, γ indicates a discount factor having a value between 0 and 1,

$${max}_{A ′} Q ( {S}^{′} , {A}^{′} )$$

indicates the largest Q-value, which any action may take in the current state, and Q(S, A) indicates the Q-value for the action taken in the previous state.

In operation S205, the agent may update the Q-table 300.

The agent may update the Q-table 300 by using Equation 2.

$$Q ( S , A ) = Q ( S , A ) + α \cdot TD ( S , A ) \qquad [ Equation 2 ]$$

In Equation 2, a represents a learning rate having a value between 0 and 1. On the left side of Equation 2, Q(S, A) represents the updated Q-value. The right side of Equation 2 represents values before the update. On the right side of Equation 2, Q(S, A) represents the Q-value for the action taken in the previous state, and TD(S, A) represents the TD for the action taken in the previous state.

The agent may update the Q-table by repeating operations S202 through S205. The Q-table updated in operation S205 may be used as a Q-table for the current state in operation S202. The agent may repeat operations S202 through S205 until the final state is reached or preset conditions are satisfied.

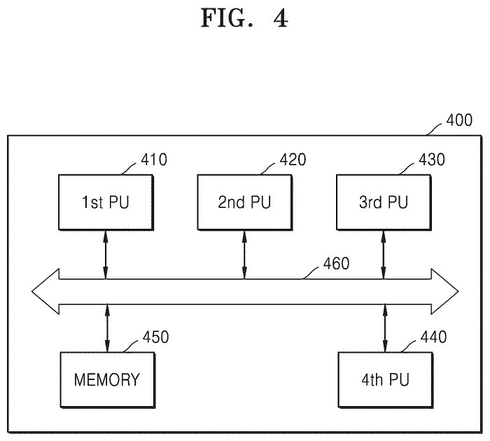

FIG. 4 is a diagram of a system 400 according to at least one embodiment.

The system 400 may include a memory 450 configured to store one or more instructions, a plurality of processing units 410 through 440, and a bus 460 for data transmission between the memory 450 and the plurality of processing units.

The memory 450 may include a volatile memory, such as dynamic RAM (DRAM) and static RAM (SRAM), or a non-volatile memory, such as flash memory, phase change RAM (PRAM), magnetic RAM (MRAM), resistant RAM (ReRAM), and ferroelectric RAM (FRAM).

The processing unit may be referred to a processor, and include a processing unit (or a processor) configured to process the DNN. The processing unit may include, for example, a core of a central processing unit (CPU), a graphics processing unit (GPU), a neural processing unit (NPU), a digital signal processor (DSP), or a multi-core processor but is not limited thereto.

FIG. 4 illustrates that the system 400 includes four processing units (PU) 410-440, but the number of processing units in the system 400 is not limited thereto. The types of the plurality of processing units may be the same as and/or different from each other. For example, the plurality of processing units may include a CPU 410, a GPU 420, an NPU 430, and a DSP 440, may include a CPU 410, two GPUs 420, 430, and a NPU 440; and/or the like.

The system 400 is configured to perform learning and/or an operation for allocating a plurality of DNNs to the plurality of processing units based on the reinforcement learning. In addition, the system 400 is configured to process the plurality of DNNs respectively allocated to the plurality of processing units. To this end, the system 400 may further include components not illustrated in FIG. 4. For example, the system 400 may further include a power management unit (PMU), a clock management unit (CMU), a system bus, a universal serial bus (USB), a peripheral component interface (PCI), a wired interface, a wireless interface, firmware, an operating system (OS), embedded software, codec, a video module (for example, a camera interface), a joint photographic experts group (JPEG) processor, a video processor, a mixer, a 3-dimensional (3D) graphics core, an audio system, a driver, and/or the like; but is not limited thereto.

The system 400 may include (and/or be included in) a system-on-chip, in which blocks having various functions are integrated into a single semiconductor chip. The system 400 may be mounted on an electronic device, and the electronic device may include, for example, a mobile device, such as a smartphone, a tablet personal computer PC), a mobile phone, a personal digital assistant (PDA), a laptop, a wearable device, a global positioning system (GPS) device, an e-book terminal, a digital broadcasting terminal, an MP3 player, a digital camera, a wearable computer, and/or the like. For example, the electronic device may also include an internet of things (IOT) device or an electric vehicle.

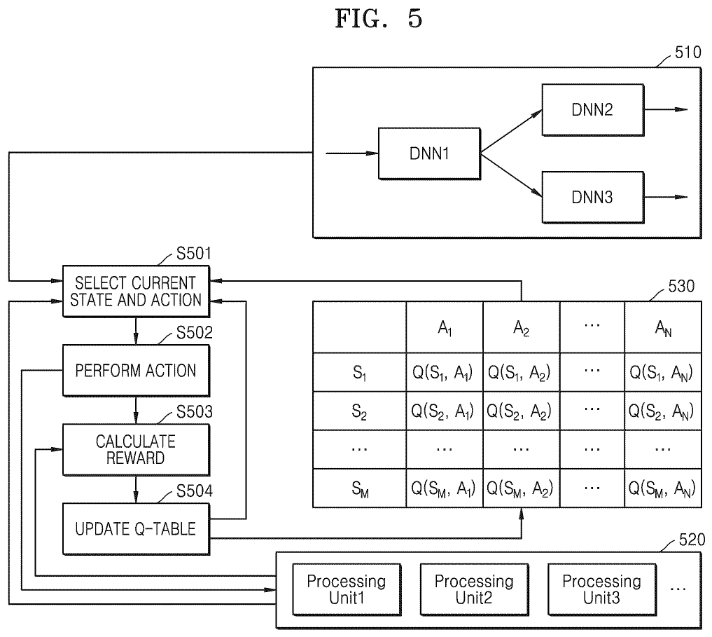

FIG. 5 is a diagram describing a learning method for respectively allocating a plurality of DNNs to a plurality of processing units, according to at least one embodiment.

Optimally and respectively allocating a plurality of DNNs to a plurality of processing units is a complicated issue. The reason is because there are many conditions to consider, such as utilization of each processing unit, temperature, process time, process accuracy, energy consumption, and memory access competition of a plurality of processing units.

The present disclosure describes learning to respectively allocate a plurality of DNNs to a plurality of processing units based on the system 400 of embodiments with reference to FIG. 4. Learning for allocation may be based on reinforcement learning. The learning for allocation may be based on Q-learning.

Referring to FIG. 5, at least one processing unit (hereinafter, referred to as a processing unit) of the plurality of processing units 410-440 of the system 400 may, as an agent, perform operations S501 through S504 illustrated in FIG. 5. For example, the processing unit may include a CPU but is not limited thereto. The processing unit acting as the agent may also be referred to as a controller.

In operation S501, the processing unit selects the current state, and selects an action to be performed in the current state.

For example, the processing unit may receive information about a plurality of DNNs 510 and/or information about a plurality of processing units 520 to select the current state. The plurality of DNNs 510 may include DNNs, which are subject to processing of the system 400. For example, the plurality of DNNs 510 may include at least one multiple DNNs but are not limited thereto. The plurality of processing units 520 may include the plurality of processing units 410-440 in FIG. 4.

Information about the plurality of DNNs 510 may include at least one of the number of DNNs, types of DNNs, the number of operations thereof, and the number of DNNs including more operations than a preset number of operations. The operation may mean one of a multiplication operation, an accumulation operation, and a multiplication-accumulation (MAC) operation. The DNN including a larger number of operations than a preset number may mean a heavy DNN having a large amount of operations. For example, the preset number may be thousands but is not limited thereto. The number of operations included in a known type of DNN, such as ResNet-50, is known information. Accordingly, the type of DNN may include information that may replace the number of operations of the DNN.

The information about the plurality of processing units 520 may include at least one of the number, type, temperature (on-chip temperature), utilization of the processing units, and/or the like. The temperature thereof may include an average temperature, a maximum temperature, a minimum temperature, and/or an instantaneous temperature. The utilization thereof may be an average utilization, a maximum utilization, a minimum utilization, and/or an instantaneous utilization.

The processing unit may receive information about a memory to select the current state. The memory may include memory accessed by the plurality of processing units 520 to process the plurality of DNNs 510. For example, the memory may include the memory 450 in FIG. 4. Information about the memory may include information about the utilization of the memory. The utilization of the memory may be an average utilization, a maximum utilization, a minimum utilization, or an instantaneous utilization of the memory.

The processing unit may select the current state corresponding to the state of the system 400 from a plurality of preset states. The state of the system 400 may be determined by information about the plurality of processing units 520 and/or information about the memory received by the processing unit. Accordingly, the processing unit may select the current state corresponding to at least one of the utilization and temperature of each of the plurality of processing units 520. In addition, the processing unit may select the current state corresponding to the utilization of the memory.

The processing unit may select the current state corresponding to information about the plurality of DNNs 510 from the plurality of preset states. Accordingly, the processing unit may select the current state corresponding to the number of the plurality of DNNs 510. In addition, the processing unit may select the current state corresponding to the number of heavy DNNs included in the plurality of DNNs 510.

The processing unit may select an action having the maximum quality in the current state from preset actions. To this end, the processing unit may select an action for the maximum Q-value in the current state by using a Q-table 530. For example, when the current state is selected as S₂ and Q(S₂, A₁) is the largest among Q(S₂, A₁), Q(S₂, A₂), . . . , Q(S₂, A_{N}), A₁ may be selected as the action. Therefore, the current state and/or action may be selected without human intervention and/or supervision.

Alternatively, the processing unit may select an action based on an algorithm in the current state. The algorithm may include an algorithm for performing an exploration without limiting the action of the processing unit in the exploitation. For example, the algorithm may include an epsilon (ϵ)-greedy algorithm but is not limited thereto.

In operation S502, the processing unit performs an action selected in the current state.

The action may include respective allocation of the plurality of DNNs 510 to the plurality of processing units 520 in a preset combination. In addition, the action may include setting the frequency or voltage of each of the plurality of processing units 520 with preset values.

As the action is performed, the plurality of processing units 520 may process the allocated plurality of DNNs 510. In addition, the plurality of processing units 520 may process the allocated plurality of DNNs 510 at a set frequency or voltage.

In operation S503, the processing unit calculates a reward for the performed action.

The reward may be calculated based on whether the process of the plurality of DNNs 510 according to the action selected in the current state has been performed to satisfy preset constraints. In at least some embodiments, the preset constraints are determined by conditions for efficiently and respectively allocating the plurality of DNNs 510 to the plurality of processing units 520. The preset constraints may include at least one of the time and accuracy of the process of the plurality of DNNs 510 according to the action selected in the current state, and the temperature and energy consumption of the plurality of processing units 520 during the runtime of the process.

The processing unit may collect information about the plurality of processing units 520 during the runtime of the process to determine whether the process of the plurality of DNNs 510 according to the action selected in the current state has been performed to satisfy preset constraints.

For example, the processing unit may calculate the reward in a manner that the reward is dependent on at least one of the time and accuracy of the process of the plurality of DNNs 510 according to the action selected in the current state, and the temperature and the energy consumption of each of the plurality of processing units 520 during the runtime of the process. For example, the processing unit may calculate a lower reward for a longer time of the process, a higher reward for higher accuracy of the process, a lower reward for higher temperature of each of the plurality of processing units 520 during the runtime of the process, or a lower reward for higher energy consumption of the plurality of processing units 520 during the runtime of the process.

In operation S504, the processing unit may update the Q-table 530.

The processing unit may update the Q-table 530 by updating the Q-value for the action selected in the current state. For example, when the current state is S₂ and the selected action is A₁, the Q-table 530 may be updated by updating Q (S₂, A₁). Examples described with reference to FIGS. 2 and 3 may be used for updating the Q-table 530.

The state of the system may be changed as the process of the plurality of DNNs 510 is performed according to the action selected in the current state. The processing unit may collect changed information about the plurality of processing units 520 and changed information about the memory thereof, to select the next state corresponding to the changed state of the system. With the transition of the state, the processing unit may repeatedly perform operations S501 through S504.

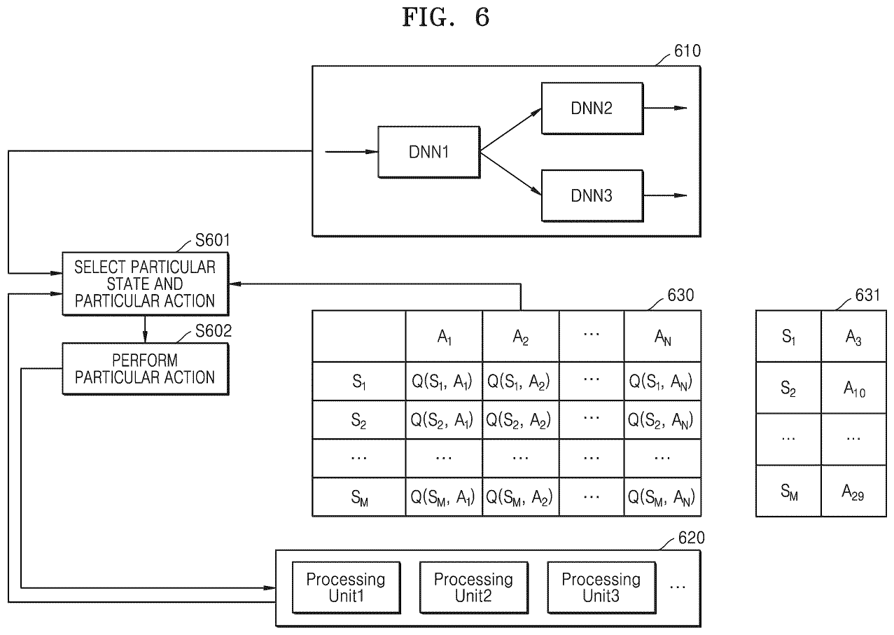

FIG. 6 is a diagram describing a method of respectively allocating the plurality of DNNs to the plurality of processing units, according to at least one embodiment.

A Q-table 630 may be obtained from the learning described with reference to FIG. 5. In the learning, as the time and accuracy of the process and the temperature and energy consumption of the processing unit are reflected in the reward, the Q-table 630 may provide an efficient policy for allocating a plurality of DNNs 610 to a plurality of processing units 620.

In operation S601, the processing unit selects a particular state, and selects a particular action to be performed in the particular state. In operation S601, descriptions of operation S501 given with reference to FIG. 5 may be applied. However, in operation S601, the Q-table 630, in which the learning has been completed, may be used for selection of the particular action.

In operation S602, the processing unit performs the particular action selected in the particular state. In operation S602, descriptions of operation S502 given with reference to FIG. 5 may be applied.

The Q-table 630 in FIG. 6 may be replaced with data including information about preset states and actions having maximum quality in the preset states. For example, when the preset states are Sᵢ through S_{M}, the action having the largest Q-value in Sᵢ is A₃, the action having the largest Q-value in S₂ is A₁₀, and the action having the largest Q-value in S_{M} is A₂₉, the data may be expressed as shown in a table 631 illustrated in FIG. 6 but is not limited thereto.

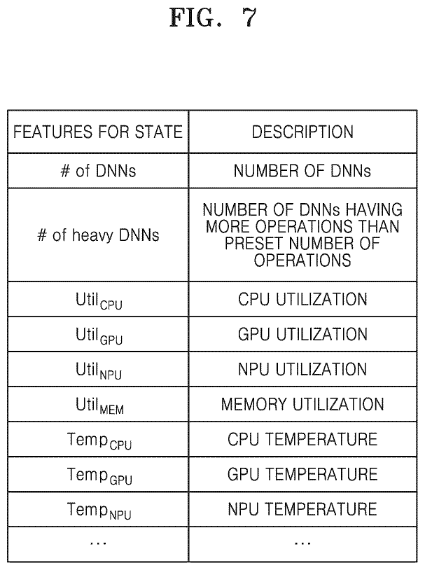

FIG. 7 is a table describing features for states according to at least one embodiment.

The preset states may be determined by features for describing the environment in relation to allocating the plurality of DNNs to the plurality of processing units. FIG. 7 illustrates various features according to at least one embodiment.

As a first feature, the number of DNNs (#of DNNs) may be used to determine the state. The number of DNNs may be used to consider various DNNs as well as particular DNNs.

As a second feature, the number of DNNs having more operations than a preset number of operations (that is, #of heavy DNNs) may be used to determine the state. Because the process of heavy DNNs requires a large amount of resources, efficient distribution of resources may be induced, as the “#of heavy DNNs” is used as an independent feature of the “#of DNNs”.

As a third feature, the utilization of each of the plurality of processing units may be used to determine the state. FIG. 7 lists a CPU utilization Util_{CPU}, a GPU utilization Util_{GPU}, and an NPU utilization Utilspu but is not limited thereto, and the utilization of each of the plurality of processing units included in the system may be used as a feature.

As a fourth feature, the utilization of the memory Util_{MEM} may be used to determine the state. Accordingly, efficient use of memory bandwidth may be induced in the process of the plurality of DNNs by the plurality of processing units.

As a fifth feature, the temperature of each of the plurality of processing units may be used to determine the state. By considering on-chip temperature, overheating of the plurality of processing units may be prevented. FIG. 7 lists a CPU temperature Tempcpu, a GPU temperature Temp_{GPU}, and an NPU temperature Temp_{NPU} but is not limited thereto, and the temperature of each of the plurality of processing units included in the system may be used as a feature.

In the example embodiments, features are not limited to the listed embodiments, and various features describing the environment in relation to allocating the plurality of DNNs to the plurality of processing units may be used.

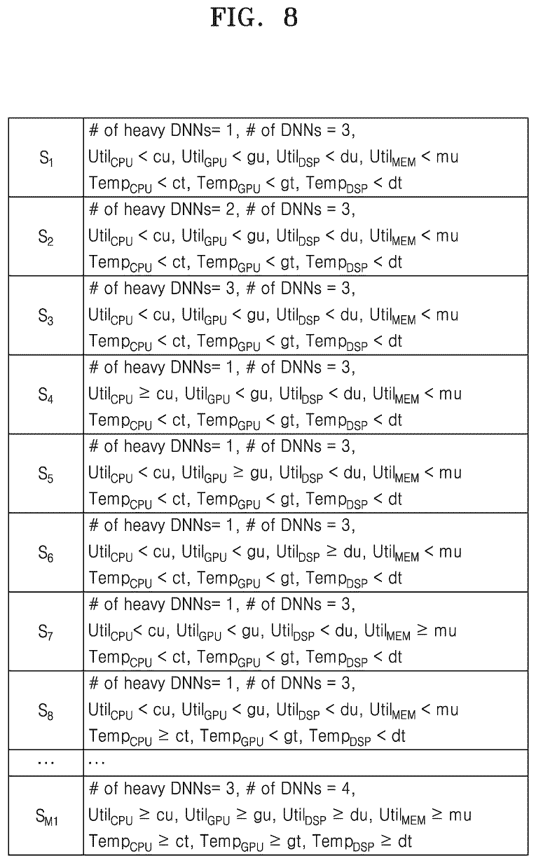

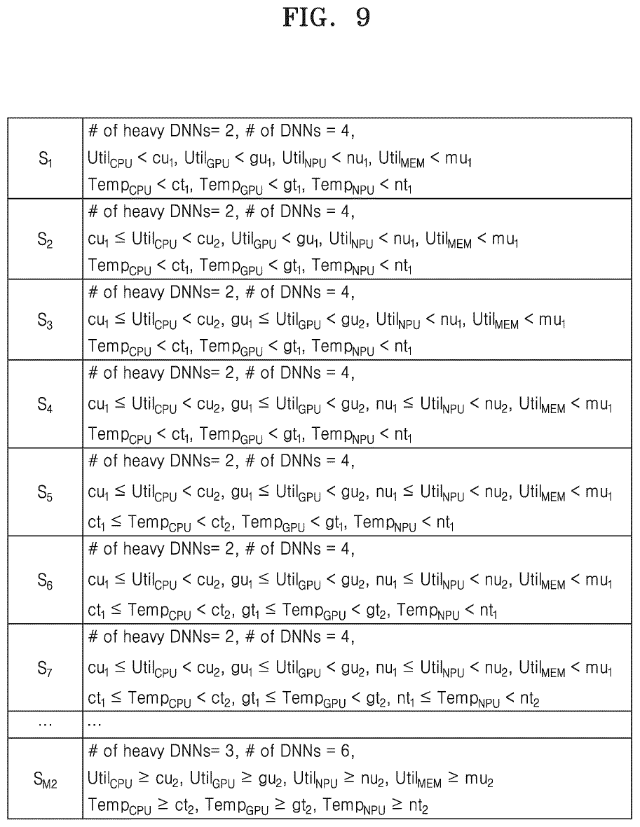

FIGS. 8 and 9 are tables describing states according to embodiments.

In the issue of allocating the plurality of DNNs to the plurality of processing units, the environment to be considered is complicated. Each manufacturer has a different hardware configuration of the processing unit, and changes in the states of the plurality of processing units during the runtime are different. In addition, modeling the environment of the plurality of processing units sharing resources is a difficult task.

In the inventive concepts, the embodiments for respectively allocating the plurality of DNNs to the plurality of processing units by using a finite number of preset states may be provided. The plurality of preset states may cover the entire range of at least one of the utilization and the temperature of each of the plurality of processing units, and the utilization of the memory. A complex environment may be arranged by the plurality of preset states, and a policy for efficiently allocating the plurality of DNNs to the plurality of processing units may be provided.

Referring to FIG. 8, a plurality of preset states S₁ through S_{M1} may include first through M1th states S₁ through S_{M1}. Features for the plurality of preset states S₁ through S_{M1} may include the number of heavy DNNs(#of heavy DNNs) having more operations than the preset number, the number of DNNs(of DNNs), the CPU utilization Util_{CPU}, the GPU utilization Util_{GPU}, a DSP utilization Util_{DSP}, a memory utilization Util_{MEM}, the CPU temperature Tempere, the GPU temperature Tempopu, and the DSP temperature Temp_{DSP}.

The plurality of preset states S₁ through S_{M1} may be mutually exclusive in at least one feature. The first state S₁ may be a state, in which the number of heavy DNNs is 1, the number of DNNs is 3, the CPU utilization Util_{CPU} is less than a preset number cu, the GPU utilization Util_{GPU} is less than a preset number gu, the DSP utilization Util_{DSP} is less than a preset number du, the memory utilization Util_{MEM} is less than a preset number mu, the CPU temperature Tempere is less than a preset number ct, the GPU temperature Tempopu is less than a preset number gt, and the DSP temperature Temppsp is less than a preset number dt. Because the number of heavy DNNs is 2 in the second state S₂, the second state S₂ may be exclusive to the first state S₁ with respect to the number of heavy DNNs. Because the CPU utilization Util_{CPU} is equal to or greater than cu in the fourth state S₄, the fourth state S₄ may be exclusive to the first state S₁ with respect to the CPU utilization Util_{CPU}. Because in the M1th state S_{M1}, the number of heavy DNNs is 3, the number of DNNs is 4, the CPU utilization Util_{CPU}, the GPU utilization Util_{GPU}, and the DSP utilization Util_{DSP} are greater than or equal to cu, gu, and du, respectively, the memory utilization Util_{MEM} is greater than mu, and the CPU temperature Tempcpu, the GPU temperature Temp_{GPU}, and the DSP temperature Temppsp are greater than or equal to ct, gt, and dt, respectively, the M1^{th} state S_{M1} may be exclusive to the first state S₁ with respect to all features.

The plurality of preset states S₁ through S_{M1} may cover the entire range of the utilization and temperature of each of the plurality of processing units, and may cover the entire range of utilization of the memory. Because the first state S₁ includes the CPU utilization Util_{CPU} that is less than cu and the fourth state S₄ includes the CPU utilization Util_{CPU} that is greater than or equal to cu, the first state S₁ and the fourth state S₄ may cover the entire range (that is, 0% to 100%) of the CPU utilization Util_{CPU}. Similarly, because the first state S₁ includes the GPU utilization Util_{GPU} that is less than gu and the DSP utilization Util_{DSP} that is less than du and the M1^{th} state S_{M1} includes the GPU utilization Util_{GPU} that is greater than or equal to gu and the DSP utilization Util_{DSP} that is greater than or equal to du, the first state S₁ and the M1^{th} state S_{M1} may cover the entire range (that is, 0% to 100%) of the GPU utilization Util_{GPU} and the DSP utilization Util_{DSP}.

Similarly, because the first state S₁ includes the memory utilization Util_{MEM} that is less than mu and the seventh state S₇ includes the memory utilization Util_{MEM} that is greater than or equal to mu, the first state S₁ and the seventh state S₇ may cover the entire range (that is, 0% to 100%) of the memory utilization Util_{MEM}. Similarly, because the first state S₁ includes the CPU temperature Tempcpu, the GPU temperature Temp_{GPU}, and the DSP temperature Temp_{DSP}, which are respectively less than ct, gt, and dt, and the M1^{th} state S_{M1} includes the CPU temperature Tempcpu, the GPU temperature Tempopu, and the DSP temperature Temp_{DSP}, which are respectively greater than or equal to ct, gt, and dt, the first state S₁ and the M1^{th} state S_{M1} may cover the entire range of the CPU temperature Tempcpu, the GPU temperature Temp_{GPU}, and the DSP temperature Temp_{DSP}.

A plurality of preset states may cover the entire range of the utilization and temperature of each of a plurality of processing units, and cover the entire range of the utilization of a memory, and because the plurality of preset states are exclusive to each other with respect to at least one feature, one state corresponding to a state of a system may be selected from the plurality of preset states.

Referring to FIG. 9, the plurality of preset states S₁ through S_{M2} may include first through M2^{nd} states S₁ through S_{M2}. Features for the plurality of preset states S₁ through S_{M2} may include the number of heavy DNNs(#of heavy DNNs) having more operations than the preset number, the number of DNNs(#of DNNs), the CPU utilization Util_{CPU}, the GPU utilization Util_{GPU}, the NPU utilization Util_{NPU}, the memory utilization Util_{MEM}, the CPU temperature Tempcpu, the GPU temperature Tempopu, and the NPU temperature Temp_{NPU}.

The plurality of predetermined states S₁ through S_{M2} may be distinguished from one another by a subdivided utilization range and temperature range. Accordingly, when, in the embodiment with reference to FIG. 8, the utilization and temperature are divided by one boundary value, in the embodiment with reference to FIG. 9, the utilization and temperature may be divided by two boundary values. The CPU utilization Util_{CPU} may be divided, by boundary values of cu₁ and cu₂, into a section less than cu₁, a section greater than or equal to cu and less than cu₂, and a section greater than or equal to cu₂. Similarly, the CPU temperature Tempcpu may be divided, by boundary values of ct₁ and ct₂, into a section less than ct₁, a section greater than or equal to ct₁ and less than ct₂, and a section greater than or equal to ct₂. In the embodiments with reference to FIG. 9, the utilization and the temperature are divided by two boundary values but the number of boundary values is not limited thereto.

The boundary values of the utilization and the temperature may be set to any values. For example, cu₁ may be 25% and cu₂ may be 75%, but the embodiment is not limited thereto. For example, ct₁ may be 50° C. and ct₂ may be 70° C. but the embodiment is not limited thereto. The boundary values of the utilization may be set equal to or different from each other. For example, at least two of cu₁, gu₁, nu₁, and mu₁ may be the same as or different from each other. For example, at least two of cu₂, gu₂, nu₂, and mu₂ may be the same as or different from each other. Similarly, the boundary values of the temperature may be set equal to or different from each other. For example, at least two of ct₁, gt₁, and nt₁ may be the same as or different from each other. For example, at least two of ct₂, gt₂, and nt₂ may be the same as or different from each other.

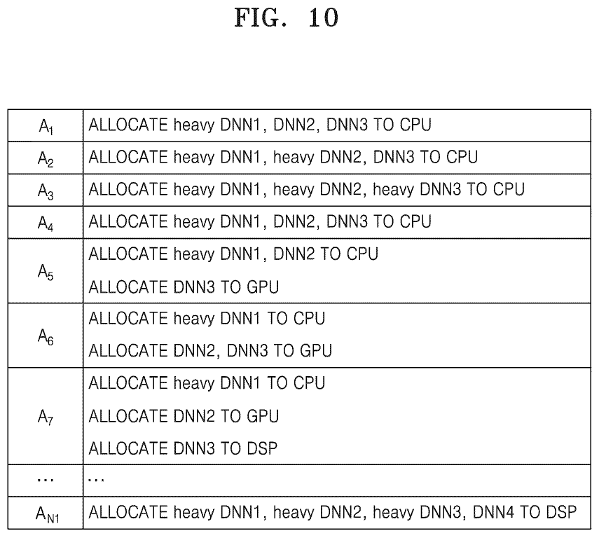

FIG. 10 is a table of actions according to at least one embodiment.

A plurality of preset actions A₁ through A_{N1} may include respectively allocating a plurality of DNNs to a plurality of processing units in a preset combination.

The plurality of preset actions A₁ through A_{N1} may cover all combinations allocable in the plurality of preset states. In the embodiment with reference to FIG. 10, the plurality of preset actions A₁ through A_{N1} may include all combinations allocable in the plurality of preset states S₁ through S_{M1} in FIG. 8. For example, for the first state S₁ in FIG. 8, a plurality of preset actions A₁ through A_{N1} may include actions respectively allocating a first DNN (heavy DNN1), a second DNN (DNN2), and a third DNN (DNN3) to a CPU, a GPU, and a DSP, such as a first action A₁ allocating a first DNN (heavy DNN1), a second DNN (DNN2), and a third DNN (DNN3) to a CPU, a fifth action A₅ allocating the first DNN (heavy DNN1) and the second DNN (DNN2) to a CPU, and the third DNN (DNN3) to a GPU, a sixth action A₆ allocating the first DNN (heavy DNN1) to a CPU, and the second DNN (DNN2) and the third DNN (DNN3) to a GPU, and a seventh action A₇ allocating the first DNN (heavy DNN1) to a CPU, the second DNN (DNN2) to a GPU, and the third DNN (DNN3) to a DSP.

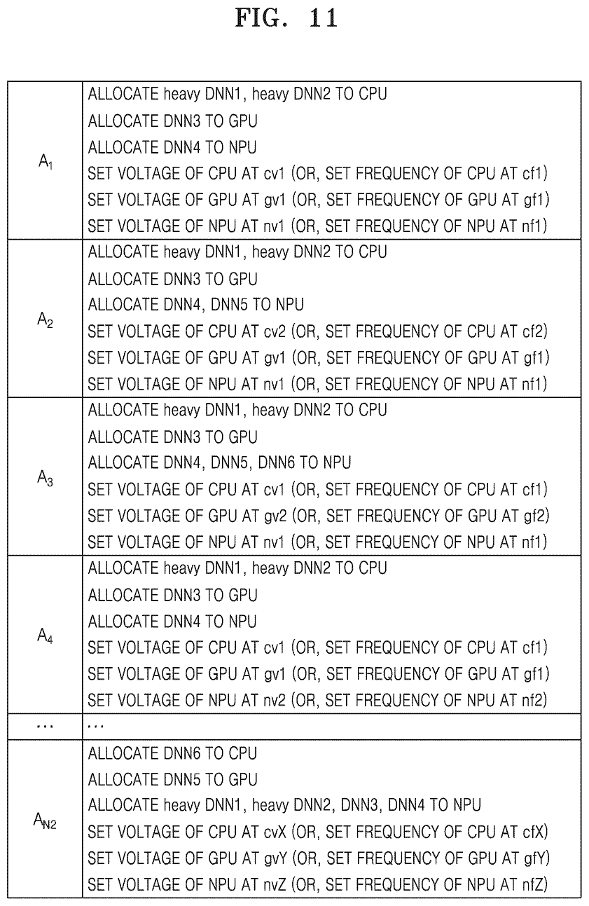

FIG. 11 is a table of actions according to at least one embodiment.

The plurality of preset actions A₁ through A_{N2} may include respectively allocating the plurality of DNNs to the plurality of processing units in a preset combination, and setting at least one value of a voltage and frequency of each of the plurality of processing units as a preset value. A policy on the voltage and frequency for the processing units to process the plurality of DNNs in a time and energy efficient manner may be provided by the plurality of preset actions A₁ through A_{N2}.

Setting the voltage and frequency to preset values may include scaling the voltage and frequency to preset values. The preset values of the voltage and frequency may be determined according to specifications of the plurality of processing units. For example, values for the frequency of a CPU may be determined according to the frequency specification of the CPU of the manufacturer.

In the first action Aⱼ and the fourth action A₄, the plurality of DNNs may be respectively allocated to the plurality of processing units in the same combination. The first DNN (heavy DNN1) and the second DNN (heavy DNN2) may be allocated to a CPU, the third DNN (DNN3) may be allocated to a GPU, and a fourth DNN (DNN4) may be allocated to an NPU. In the first action A1, a voltage of an NPU may be set at nv1 (and/or the frequency of the NPU set at nf1), and in the fourth action A₄, the voltage of the NPU may be set at nv2 (and/or the frequency of the NPU set at nf2). In the learning, as an action having better quality is selected from the first action Aⱼ and the fourth action A₄, the voltage (and/or frequency) of a more time- and energy-efficient NPU may be searched for in a situation where the plurality of DNNs are allocated to the plurality of processing units.

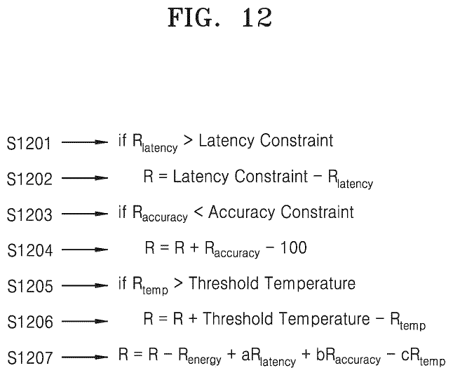

FIG. 12 is a diagram describing a reward according to at least one embodiment.

The processing unit obtains the time and accuracy of the process of the plurality of DNNs according to the action selected in the current state, and the temperature and the energy consumption of each of the plurality of processing units during the runtime of the process.

The processing unit determines the reward as to be dependent on at least one of the time and accuracy of the process and the temperature and the energy consumption of each of the plurality of processing units. The processing unit may, for example, calculate the reward to have a larger value as the time of the process decreases. The processing unit may calculate the reward to have a larger value as the accuracy of the process increases. The processing unit may calculate the reward to have a larger value as the temperature of each of the plurality of processing units decreases. The processing unit may calculate the reward to have a larger value as the energy consumption of the plurality of processing units decreases.

In at least one embodiment, the processing unit may calculate the reward according to operations in FIG. 12.

In operation S₁₂₀₁, the processing unit compares a time R_{latency} of the process with a latency constraint. The time R_{latency} of the process may be the total time of the process of the plurality of DNNs according to the action. Alternatively, the time R_{latency} of the process may be the time of the process of any DNN in the process of the plurality of DNNs according to the action. When the time R_{latency} of the process is greater than the latency constraint, the process may proceed to operation S1202. Otherwise, the process may proceed to operation S1203.

In operation S1202, the processing unit calculates a reward R by subtracting the time R_{latency} of the process from the latency constraint. For example, when the latency constraint is 0.5 s and the time R_{latency} of the process is 0.7 s, the reward R may be −0.2.

In operation S1203, the processing unit compares the accuracy R_{accuracy} of the process with an accuracy constraint. The accuracy R_{accuracy} of the process may be an average accuracy of the process of each DNN in the process of the plurality of DNNs according to the action. Alternatively, the accuracy R_{accuracy} of the process may be the accuracy of the process of any one DNN in the process of the plurality of DNNs according to the action. When the accuracy R_{accuracy} of the process is less than the accuracy constraint, the process may proceed to operation S1204. Otherwise, the process may proceed to operation S1205.

In operation S1204, the processing unit calculates the reward R by adding the accuracy R_{accuracy} of the process to the reward R and subtracting 100 from the addition result. For example, when the reward R is 0 and the accuracy R_{accuracy} of the process is 87%, the calculated reward R may be −13.

In operation S1205, the processing unit compares temperature Rₜₑₘₚ of the plurality of processing units with a temperature constraint (threshold temperature). The temperature Rₜₑₘₚ of the plurality of processing units may be the maximum temperature or an average temperature of the plurality of processing units during the runtime of the process. When the temperature Rₜₑₘₚ of the plurality of processing units is greater than the threshold temperature, the process may proceed to operation S1206. Otherwise, the process may proceed to operation $1207.

In operation S1206, the processing unit calculates the reward R by adding the threshold temperature to the reward R and subtracting the temperature Rₜₑₘₚ from the addition result. For example, when the reward R is 0, the threshold temperature is 75° C., and the temperature Rₜₑₘₚ is 77° C., the calculated reward R may be −2.

In operation S1207, the processing unit calculates the reward R from the energy consumption R_{energy} of the plurality of processing units, the time R_{latency} of the process, the accuracy R_{accuracy} of the process, and the temperature Rₜₑₘₚ of the plurality of processing units. The energy consumption R_{energy} of the plurality of processing units may be energy consumption of the plurality of processing units during the runtime of the process. To correct scales of the energy consumption R_{energy}, the time R_{latency} of the process, the accuracy R_{accuracy} of the process, and the temperature Rₜₑₘₚ of the plurality of processing units, constants a, b, and c may be used.

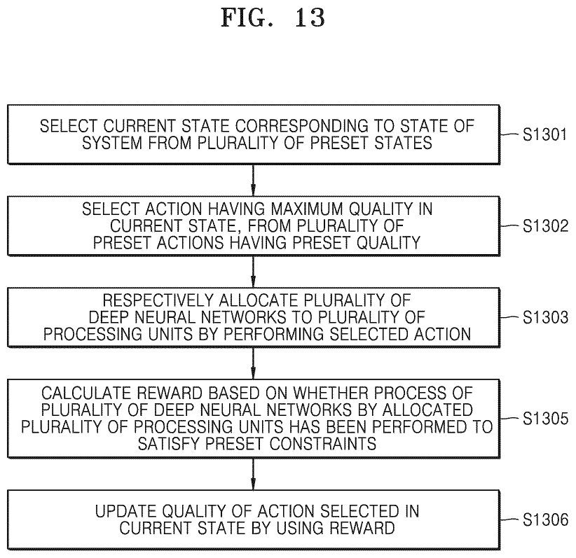

FIG. 13 is a flowchart of a learning method of a system for allocating DNNs to processing units based on reinforcement learning, according to at least one embodiment.

In operation S1301, the processing unit selects the current state corresponding to the state of the system from a plurality of preset states. The state of the system may be determined by at least one of a utilization and temperature of each of the plurality of processing units, and the utilization of the memory. Accordingly, the processing unit may select the current state corresponding to at least one of the utilization and temperature of each of the plurality of processing units, and the utilization of the memory.

In addition, the processing unit may select the current state corresponding to at least one of the number of DNNs and the number of DNNs having more operations than the preset number of DNNs, in the plurality of preset states. In these cases, the operation may mean at least one of a multiplication operation, an accumulation operation, and a MAC operation.

In operation S1302, the processing unit selects an action having the maximum quality in the current state, from a plurality of preset actions having preset quality. The action having the maximum quality in the current state may include an action for the maximum Q-value in the current state. The processing unit may select the action for the maximum Q-value in the current state by referring to the Q-table. The plurality of preset actions may include respectively allocating the plurality of DNNs to the plurality of processing units in a preset combination.

In operation S1303, the processing unit respectively allocates the plurality of DNNs to the plurality of processing units by performing the selected action. The plurality of processing units may process the plurality of allocated DNNs, respectively.

In operation S1305, the processing unit calculates the reward based on whether the process of the plurality of DNNs by the allocated plurality of processing units has been performed to satisfy preset constraints. The processing unit may obtain at least one of the time and accuracy of the process according to the action selected in the current state, and calculate the reward based on whether at least one of the time and accuracy of the process satisfies the preset constraints. In addition, the processing unit may obtain the temperature of each of the plurality of processing units during the runtime of the process according to the action selected in the current state, and calculate the reward based on whether the temperature of each of the plurality of processing units satisfies the preset constraints. In addition, the processing unit may calculate the reward to be dependent on at least one of the time and accuracy of the process according to the action selected in the current state, and the temperature and energy consumption of each of the plurality of processing units during the runtime of the process according to the action selected in the current state.

In operation S1306, the processing unit updates the quality of the action selected in the current state by using the reward. The processing unit may update the quality of the action selected in the current state based on the Q-learning. The processing unit may update the quality of the action by updating the Q-value for the action in the Q-table.

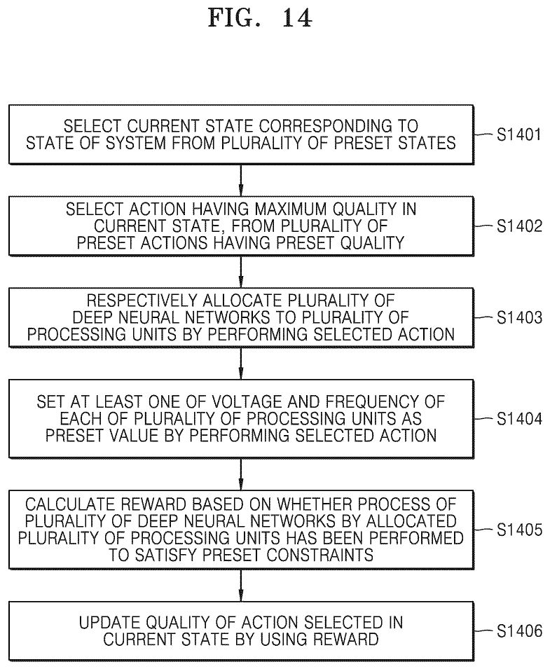

FIG. 14 is a flowchart of a learning method of a system for allocating DNNs to processing units based on reinforcement learning, according to at least one embodiment.

In operation S1401, the processing unit selects the current state corresponding to the state of the system from a plurality of preset states. The descriptions of operation S1301 in FIG. 13 may be applied to operation S1401.

In operation S1402, the processing unit selects an action having the maximum quality in the current state, from a plurality of preset actions having preset quality. The descriptions of operation S1302 in FIG. 13 may be applied to operation S1402.

In operation S1403, the processing unit respectively allocates a plurality of DNNs to a plurality of processing units by performing the selected action. The descriptions of operation S1303 in FIG. 13 may be applied to operation S1403.

In operation S1404, the processing unit sets at least one value of the voltage and/or frequency of each of the plurality of processing units to a preset value by performing the selected action. The plurality of preset actions may include setting at least one value of the voltage and frequency of each of the plurality of processing units to a preset value. The plurality of processing units may respectively process the plurality of allocated DNNs by using the set voltage or frequency.

In operation S1405, the processing unit calculates the reward based on whether the process of the plurality of DNNs by the allocated plurality of processing units has been performed to satisfy preset constraints. The descriptions of operation S1305 in FIG. 13 may be applied to operation S1405.

In operation S1406, the processing unit updates the quality of the action selected in the current state by using the reward. The descriptions of operation S1306 in FIG. 13 may be applied to operation S1406.

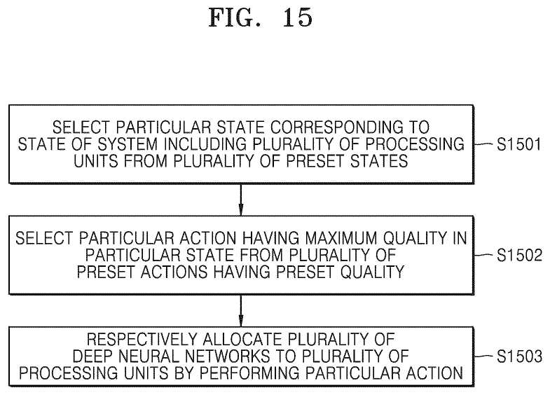

FIG. 15 is a flowchart of an operation method of a system for allocating DNNs to processing units based on reinforcement learning, according to at least one embodiment.

In operation S1501, the processing unit selects a particular state corresponding to the state of the system including a plurality of processing units from a plurality of preset states. A description of the selection of the current state in operation S1301 in FIG. 13 may be applied to the selection of the particular state.

In operation S1502, the processing unit selects a particular action having the maximum quality in the particular state, from a plurality of preset actions having preset quality. The processing unit may select the particular action for the maximum Q-value in the particular state by referring to the Q-table. The Q-table may be obtained from the learning with reference to FIGS. 13 and 14.

In operation S1503, the processing unit respectively allocates the plurality of DNNs to the plurality of processing units by performing the particular action. The particular action may include respectively allocating the plurality of DNNs to the plurality of processing units in a particular combination. The plurality of processing units may respectively process the plurality of DNNs allocated according to the particular action.

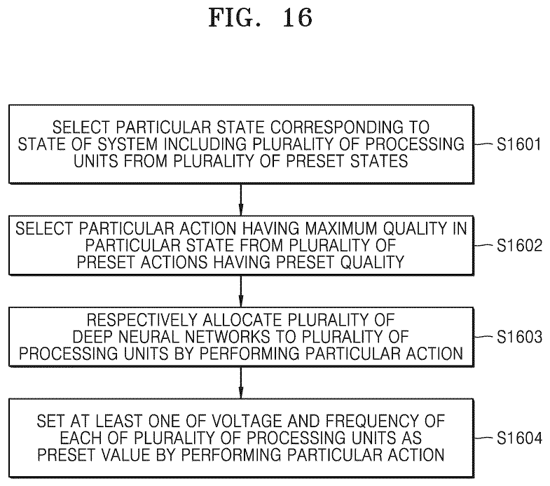

FIG. 16 is a flowchart of an operation method of a system for respectively allocating DNNs to processing units based on reinforcement learning, according to at least one embodiment.

In operation S1601, the processing unit selects a particular state corresponding to the state of the system including a plurality of processing units from a plurality of preset states. The descriptions of operation S1501 in FIG. 15 may be applied to operation S1601.

In operation S1602, the processing unit selects a particular action having the maximum quality in the particular state, from a plurality of preset actions having preset quality. The descriptions of operation S1502 in FIG. 15 may be applied to operation S1602.

In operation S1603, the processing unit respectively allocates the plurality of DNNs to the plurality of processing units by performing the particular action. The descriptions of operation S1503 in FIG. 15 may be applied to operation S1603.

In operation S1604, the processing unit sets at least one value of the voltage and frequency of each of the plurality of processing units to a preset value by performing the particular action. The particular action may include setting at least one value of the voltage and frequency of each of the plurality of processing units to a particular value. The plurality of processing units may respectively process the plurality of DNNs allocated according to the particular action by using the voltage or frequency set according to the particular action.

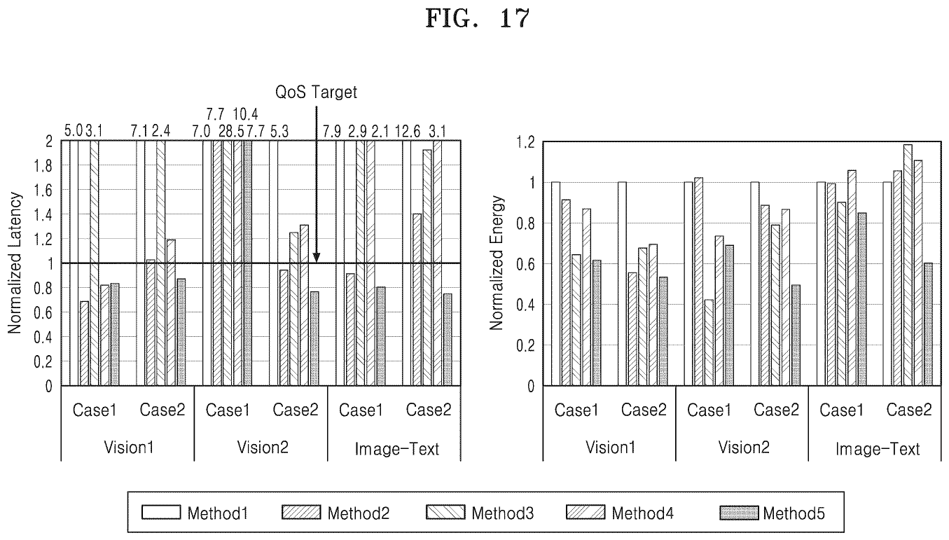

FIG. 17 illustrates graphs of performance of a process, according to at least one embodiment.

The graphs represent the result of processing a plurality of DNNs allocated according to embodiments, and the result of processing a plurality of DNNs allocated by using conventional methods. In the graphs, a method1, a method2, a method3, and a method4 represents conventional methods, and a method5 represents a method according to embodiments of the inventive concepts. In the graphs, a case1 represents a case where the plurality of DNNs are processed by using a first application processor (AP), and a case2 represents a case where the plurality of DNNs are processed by using a second AP. The first AP may include a first plurality of processing units, and the second AP may include a second plurality of processing units. In the graphs, a vision1 represents the process of a first plurality of DNNs for image processing, a vision2 represents the process of a second plurality of DNNs for image processing, and an image-text represents the process of a third plurality of DNNs for image-text conversion.

Referring to the graphs, the method5 according to the embodiments satisfies the target quality for latency except for the case1 of the vision2. The method5 yields an energy saving of an average of 30.2%, 18.0%, and 29.0% with respect to the method2, the method3, and the method4, respectively. The method5 provides the process of time- and energy-efficient plurality of DNNs with respect to other conventional methods.

The embodiments described above may be implemented as processing circuitry including a hardware component, a software component, and/or a combination of a hardware component and a software component. For example, the devices, methods, and components described above in the embodiments may be implemented by using, for example, a processor, a controller, an arithmetic logic unit (ALU), a DSP, a microcomputer, a field programmable gate array (FPGA), a microprocessor, or one or more general purpose computers or special purpose computers, such as a certain device capable of executing instructions and responding thereto. A processing device may include an operating system (OS), and perform software applications performed on the OS. In addition, the processing device may also, in response to execution of the software, access, store, manipulate, process, and generate data. For convenience of understanding, although the processing device has been described for the case in which one processing device has been used, one of ordinary skill in the art may understand that the processing device may include a plurality of processing elements and/or multiple types of processing elements. For example, the processing device may include a plurality of processors or one processor and one controller. In addition, other processing configurations, such as a parallel processor, may also be used.

The software may include a computer program, code, an instruction, or a combination thereof, and may configure the processing device to operate as desired, or command the processing device independently or collectively. Software and/or data may, to be interpreted by a processing device or provide instructions or data to the processing device, be permanently or temporarily embodied in any type of machine, a component, a physical device, virtual equipment, a computer storage medium or device, or a transmitted signal wave. Software may be distributed over a networked computer system, and may also be stored or executed in a distributed manner. Software and data may be stored in a computer-readable recording medium.

The method according to the embodiment may be implemented in a form of program instructions executable by using various computer means, and may be recorded in a computer-readable medium. The computer-readable medium may include program instructions, data files, data structures, or the like, separately or in a combination thereof. The program instructions to be recorded on the medium may be those particularly designed and configured for the embodiments, or may also be available to one of ordinary skill in the art of computer software. Examples of the computer-readable recording media may include magnetic media, such as a hard disk, a floppy disk and magnetic tape, optical media, such as a compact disk (CD)-read-only memory (ROM) (CD-ROM) and a digital versatile disk (DVD), a magneto-optical medium, such as a floptical disk, and hardware devices particularly configured to store and perform program instructions, such as ROM, random access memory (RAM), flash memory. Examples of program instructions may include machine language code, such as code generated by a compiler, as well as high-level language code, that is executable by a computer using an interpreter, etc.

As described above, by using reinforcement learning to allocate a plurality of DNNs to a plurality of processors, an optimal distribution of the DNNs is applied to the plurality of processors, thereby improving the efficiency of the DNNs, reducing computation times, and creating an energy savings with respect to conventional methods.

While the inventive concepts have been particularly shown and described with reference to embodiments thereof, it will be understood that various changes in form and details may be made therein without departing from the spirit and scope of the following claims.

What is claimed is:

1. A system configured to allocate deep neural networks to a plurality of processors based on reinforcement learning, the system comprising:
a memory configured to store one or more instructions; and
the plurality of processors, wherein at least one processor of the plurality of processors, by performing the one or more instructions, is configured to:
select a current state from a plurality of preset states, the current state corresponding to a state of the system and to a plurality of preset actions having at least one preset quality,
select an action, of the plurality of preset actions, having a maximum quality in the current state and respectively allocate a plurality of deep neural networks (DNNs) to the plurality of processors based on the selected action,
determine a reward based on whether a process of the plurality of DNNS by the allocated plurality of processors satisfies preset constraints, and
update the at least one preset quality of the action selected in the current state based on the reward.

2. The system of claim 1, wherein the at least one processor is configured to select the current state based on at least one of a utilization or a temperature of each of the plurality of processors.

3. The system of claim 2, wherein the at least one processor is further configured to select the current state corresponding to the utilization of the memory.

4. The system of claim 3, wherein the plurality of preset states represent a finite number of states covering a range of the utilization of the memory and at least one of the utilization or the temperature of each of the plurality of processors.

5. The system of claim 1, wherein the at least one processor is configured to select a preset state, from the plurality of preset states, as the current state, based onto at least one of
a number of the DNNs corresponding to the preset state, or
the number of the DNNs comprising a number of operations greater than a preset number from the DNNs.

6. The system of claim 5, wherein the operations comprise at least one of a multiplication operation, an accumulation operation, or a multiplication-accumulation (MAC) operation.

7. The system of claim 1, wherein the plurality of processors comprise at least one of a central processing unit (CPU), a graphics processing unit (GPU), a neural processing unit (NPU), or a digital signal processor (DSP).

8. The system of claim 1, wherein the plurality of preset actions comprise respectively allocating the plurality of DNNs to the plurality of processors in a preset combination.

9. The system of claim 8, wherein the plurality of preset actions further comprise setting at least one value of a voltage or a frequency of each of the plurality of processors to preset values.

10. The system of claim 1, wherein the at least one processor is further configured to set at least one value of a voltage or a frequency of each of the plurality of processors, for performing a process, according to the action selected in the current state.

11. The system of claim 1, wherein the at least one processor is further configured to
obtain at least one of time or accuracy of a process according to the action selected in the current state, and
determine the reward based on whether the at least one of the time or the accuracy of the process satisfies the preset constraints.

12. The system of claim 1, wherein the at least one processor is further configured to
obtain a temperature of the plurality of processors during a runtime of a process according to the action selected in the current state, and
determine the reward based on whether the temperature of the plurality of processors satisfies the preset constraints.

13. The system of claim 1, wherein the at least one processor is configured to calculate the reward based on at least one of
a time and accuracy of a process, according to the action selected in the current state, or
a temperature and an energy consumption of the plurality of processors during a runtime of the process according to the action selected in the current state.

14. The system of claim 1, wherein
the reinforcement learning is based on Q-learning, and
the at least one processor is further configured to update the quality of the action selected in the current state based on the Q-learning.

15. A system configured to allocate a deep neural network (DNN) based on reinforcement learning, the system comprising:
a memory configured to store one or more instructions; and
a plurality of processing units, wherein at least one processor, of the plurality of processing units, by executing the one or more instructions, is configured to
select a particular state from a plurality of preset states, the particular state corresponding to a state of the system and to a plurality of preset actions having at least one preset quality,
select a particular action, of the plurality of preset actions, having a maximum quality in the particular state, and
respectively allocate a plurality of deep neural networks to the plurality of processors based on the selection of the particular action.

16. The system of claim 15, wherein
the reinforcement learning is based on Q-learning configured to update at least one quality to maximize a reward based on the particular action, and
wherein the reward has at least one of
a larger value as a process time of a process of the plurality of DNNs, by the allocated plurality of processors and according to the particular action, decreases,
a larger value as accuracy of the process increases,
a larger value as temperature of the plurality of processors decreases during a runtime of the process, or
a larger value as energy consumption of the plurality of processors decreases.

17. The system of claim 15, wherein the plurality of preset states represent a finite number of states covering a range of utilization of the memory and at least one of the utilization or temperature of each of the plurality of processors.

18. The system of claim 15, wherein the at least one processor is further configured to
set at least one value of a voltage or a frequency of each of the plurality of processors for performing a process according to the plurality of DNNs allocated based on the selection of the particular action.

19. An operation method of allocating deep neural networks (DNNs) to processing units based on reinforcement learning, the operation method comprising:
selecting a particular state from a plurality of preset states, the particular state corresponding to a state of a system and to a plurality of preset actions having at least one preset quality;
selecting a particular action, from the plurality of preset actions, having a maximum quality in the particular state; and
respectively allocating a plurality of DNNs to a plurality of processors based on the selection of the particular action.

20. The operating method of claim 19, further comprising:
setting at least one value of a voltage or a frequency of each of the plurality of processors for processing the plurality of deep neural networks allocated based on the selection of the particular action.
